(19) United States
(12) Patent Application Publication
(10) Pub. No.: US 2025/0053973 A1
(43) Pub. Date: Feb. 13, 2025

(54) USE OF CRYPTOCURRENCY TO RELEASE A RESERVED DATA RESOURCE

(71) Applicant: The Toronto-Dominion Bank, Toronto (CA)

(72) Inventors: Milos DUNJIC, Oakville (CA); David Samuel TAX, Toronto (CA); Jonathan Joseph PRENDERGAST, West Chester, PA (US); Hitesh BAJAJ, Duluth, GA (US); Kenneth Tien Poh WONG, Oakville (CA)

(73) Assignee: The Toronto-Dominion Bank, Toronto (CA)

(21) Appl. No.: 18/447,474

(22) Filed: Aug. 10, 2023

(51) Int. Cl. G06Q 20/38; G06Q 20/06; G06Q 20/40; G06Q 20/42

(52) U.S. Cl. CPC G06Q 20/389; G06Q 20/0658; G06Q 20/403; G06Q 20/42; G06Q 2220/10

(57) ABSTRACT

Systems and methods for releasing a reserved data resource are provided. A system may receive a pre-authorization request from a second entity, the pre-authorization request defining a first account, a transaction amount, and a blockchain address to which cryptocurrency may be sent to release a reserved data resource. The system may verify that the first account defines at least an amount of first data resources equal to the transaction amount. The system may further verify that a second account defines at least a first amount of cryptocurrency having a value that is equal to the transaction amount, the second account being associated with the first account. The system may reserve a first portion of the first data resources, the first portion of the first data resources being equal to the transaction amount, and send a response to the pre-authorization request, the response including an approval message.

### TECHNICAL FIELD

The present application relates to reserving data resources and, more particularly, to systems and methods for using cryptocurrency to release a reserved data resource.

### BACKGROUND

Despite the present enthusiasm for cryptocurrencies, they have yet to gain much popularity as a means for day-to-day transactions. For example, cryptocurrencies are not commonly used in point-of-sale (POS) transactions or in ordinary online transactions.

There are a number of reasons for the reluctance of merchants to accept cryptocurrency transfers. For example, merchants may be concerned about delays associated with the completion of cryptocurrency transactions, which may be problematic in some contexts, such as in-person, retail environments where transactions must be completed with a steady cadence. As a further example, due to the volatility of cryptocurrencies, merchants may be concerned that an accepted amount of cryptocurrency may lose value between the time of sale and the time of completion of the cryptocurrency transaction. As a further example, merchants may be concerned about the possibility of a non-completion of a cryptocurrency transfer.

Improvements to the field are desired.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2 is high-level schematic diagram of a computing device;

FIG. 3 shows a simplified organization of software components stored in a memory of the computing device of FIG. 2;

FIG. 4 illustrates a method for sending a response to a pre-authorization request.

FIG. 5 illustrates a method for removing a reservation of a first portion of first data resources;

FIG. 6 illustrates a method for sending a notification identifying a difference;

FIG. 7 illustrates a method for processing a transaction in response to receiving a decline response;

FIG. 8 illustrates a first method for completing a pre-authorization request for an amount equal to a difference;

FIG. 9 illustrates a method for canceling a pre-authorization request;

FIG. 10 illustrates a method for completing a pre-authorization request; and

FIG. 11 illustrates a second method for completing a pre-authorization request for an amount equal to a difference;

Like reference numerals are used in the drawings to denote like elements and features.

### DETAILED DESCRIPTION OF VARIOUS EMBODIMENTS

In accordance with one aspect of the present disclosure, there is provided a computer system comprising: a processor; and a memory coupled to the processor and storing instructions that, when executed by the processor, cause the computer system to: receive a pre-authorization request from a second entity, the pre-authorization request defining a first account, a transaction amount, and a blockchain address to which cryptocurrency may be sent to release a reserved data resource; verify that the first account defines at least an amount of first data resources equal to the transaction amount; verify that a second account defines at least a first amount of cryptocurrency having a value that is equal to the transaction amount, the second account being associated with the first account; reserve a first portion of the first data resources, the first portion of the first data resources being equal to the transaction amount; and send a response to the pre-authorization request, the response including an approval message.

In some implementations, the processor is further configured to: verify that a transferred amount of cryptocurrency has been received at the blockchain address from the second account; determine that the transferred amount of cryptocurrency has a value that is greater than or equal to the transaction amount; and in response to determining that the transferred amount of cryptocurrency has a value that is greater than or equal to the transaction amount, remove the reservation of the first portion of the first data resources.

In some implementations, the processor is further configured to: send a notification to the second entity indicating that the transferred amount of cryptocurrency having a value greater than or equal to the transaction amount has been received at the blockchain address.

In some implementations, verifying that a transferred amount of cryptocurrency has been received at the blockchain address from the second account includes verifying one or more corresponding blockchain transactions based on the blockchain address.

In some implementations, the processor is further configured to: verify that a transferred amount of cryptocurrency has been received at the blockchain address from the second account; determine that the transferred amount of cryptocurrency has a value that is less than the transaction amount; identify a difference between the transaction amount and the value of the transferred amount of cryptocurrency; and send a notification to the second entity, the notification including the difference between the transaction amount and the value of the transferred amount of cryptocurrency.

In some implementations, the processor is further configured to: adjust the reservation of the first portion of data resources to be equal to the difference between the transaction amount and the value of the transferred amount of cryptocurrency.

In some implementations, the processor is further configured to: receive a pre-authorization release message from the second entity; and release the reservation of the first portion of the first data resources.

In some implementations, the response to the pre-authorization request includes an identification of the second account.

In some implementations, verifying that a second account defines at least a first amount of cryptocurrency having a value that is equal to the transaction amount includes verifying that the second account has sufficient unspent transaction output (UTXO) on a cryptocurrency rail.

In some implementations, the pre-authorization request is an International Organization for Standardization (ISO) 8583 compliant message, and wherein the blockchain address is indicated by one or more data elements of the ISO 8583 compliant message.

In some implementations, the pre-authorization request is received via a point-of-sale (POS) terminal.

In some implementations, the pre-authorization request is received via an online transfer gateway.

In accordance with another aspect of the present application, there is provided a computer system comprising: a processor; and a memory coupled to the processor and storing instructions that, when executed by the processor, cause the computer system to: send, to a system associated with a value transfer card, a pre-authorization request, the pre-authorization request defining a first account, a transaction amount, and a blockchain address to which cryptocurrency may be sent to release a reserved data resource; receive, from the system associated with the value transfer card, a response to the pre-authorization request; and when the response is a decline response, process the transaction amount using the value transfer card.

In some implementations, the processor is further configured to: when the response is an approve response: monitor the blockchain address for receipt of a transferred amount of cryptocurrency from a second account associated with the first account; determine that the transferred amount of cryptocurrency has been received via the blockchain address; determine that the transferred amount of cryptocurrency has a value less than the transaction amount; determine a difference between the value of the transferred amount of cryptocurrency and the transaction amount; and complete the pre-authorization request for an amount equal to the difference between the value of the transferred amount of cryptocurrency and the transaction amount.

In some implementations, the response includes an identification of the second account.

In some implementations, the processor is further configured to: when the response is an approve response: monitor the blockchain address for receipt of a transferred amount of cryptocurrency from a second account associated with the first account; determine that the transferred amount of cryptocurrency has been received via the blockchain address; determine that the transferred amount of cryptocurrency has a value greater than or equal to the transaction amount; and cancel the pre-authorization request.

In some implementations, the processor is further configured to: when the response is an approve response: receive a notification identifying a difference between the transaction amount and a value of a transferred amount of cryptocurrency; and complete the pre-authorization request for an amount equal to the difference between the transaction amount and the value of the transferred amount of cryptocurrency.

In some implementations, the processor is further configured to: when the response is an approve response: monitor the blockchain address for receipt of a transferred amount of cryptocurrency from a second account associated with the first account; determine that the transferred amount of cryptocurrency has not been received via the blockchain address; and complete the pre-authorization request.

In some implementations, the pre-authorization request is an International Organization for Standardization (ISO) 8583 compliant message, and the blockchain address is indicated by one or more data elements of the ISO 8583 compliant message.

In some implementations, the pre-authorization request is sent via a point-of-sale (POS) terminal.

In another aspect, a computer-readable storage medium may be provided. The computer-readable storage medium may include processor-executable instructions which, when executed, configure a processor to perform a method described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

A system may allow a second entity to use a pre-authorization approval as a means of transfer assurance when engaging in cryptocurrency transactions with a first entity. In this way, a standard value transfer card may be extended to support cryptocurrencies.

For example, after a first entity initiates a transaction using a standard value transfer card (e.g., in-store at a POS terminal or online at an e-commerce site), the system may submit a standard pre-authorization request for the amount of the transaction. The preauthorization request may indicate one or more cryptocurrency addresses associated with the second entity and may also indicate which type of cryptocurrency is supported. In some instances, the pre-authorization request may indicate that multiple cryptocurrencies are supported and an address associated with each such cryptocurrency may be provided.

Upon verification that each of the first entity's standard account and an associated cryptocurrency account include sufficient value to complete the transaction, an approval response may be received by the system. If either the standard account or the associated cryptocurrency account do not include sufficient value to complete the transaction, a decline response may be received by the system.

Upon receipt of an approval response, the system may proceed with the cryptocurrency transaction. In the event that the cryptocurrency transaction does not complete in a satisfactory manner, the system may complete the pre-authorization request for the entire transaction amount or for a partial transaction amount.

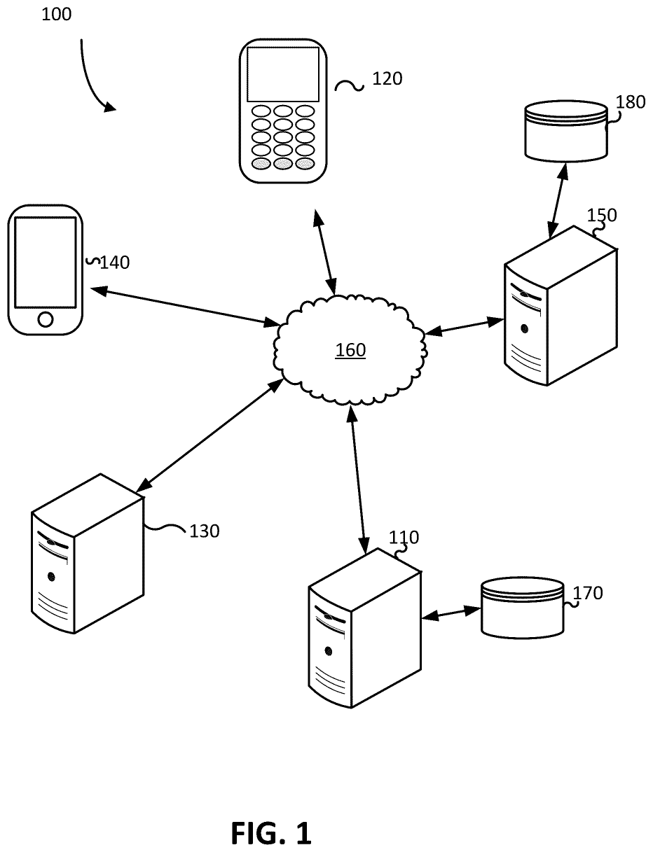

FIG. 1 is a schematic operation diagram illustrating an operating environment of an example embodiment.

As illustrated, the operating environment 100 includes a first database management system 110, a second database management system 150, a transfer rail 130, a point-of-sale (POS) terminal 120, and a client device 140 in communication via a network 160.

Each of the first database management system 110, the client device 140, the second database management system 150, the transfer rail 130, and the POS terminal 120 may be in geographically disparate locations. Put differently, one or more of the first database management system 110, the client device 140, the second database management system 150, the transfer rail 130, and the POS terminal 120 may be remote to others of the first database management system 110, the client device 140, the second database management system 150, the transfer rail server 130, and the POS terminal 120.

The first database management system 110 and the second database management system 150 may each be a single server, multiple servers, a server farm, or any other such arrangement of computing devices to implement computing server-like functionality. In some embodiments, the first database management system 110 and the second database management system 150 may track, manage, and maintain owned resources belonging to respective entities, such as the first and second entity. The resources may be represented in a database. For example, the first database management system 110 may be coupled to a first database 170 which may be provided in secure storage, and the second database management system 150 may be coupled to a second database 180 which may also be provided in secure storage. The secure storage(s) may be provided internally within the first and second database management systems 110, 150 or externally. The secure storage(s) may, for example, be provided remotely from the first and second database management systems 110, 150. For example, the secure storage(s) may include one or more data centers. The data centers may, for example, store data with bank-grade security.

In some embodiments, the first database management system and the second database management system may be the same system.

The first database 170 and the second database 180 may include data records for a plurality of accounts and at least some of the data records may define a quantity of resources associated with an entity, such as the first and second entity. Such resources may include owned resources and/or borrowed resources. The amount of resources that are available to or associated with an entity may be reflected by a resource definition defined in an associated data record. The resource definition may be or include a balance defined in an associated data record; for example a bank balance and/or an amount of available credit.

In some embodiments, the first and second database management systems 110, 150 may, for example, be financial institution servers.

The first database management system 110 and/or the second database management system 150 may interact with a blockchain network. For example, the first database management system 110 and/or the second database management systems 150 may each be a node of a blockchain network, or may each interact with a node of the blockchain network. This may allow the first database management system 110 and/or the second database management systems 150 to read data from the blockchain network and/or to update the blockchain network.

The blockchain network is a decentralized peer-to-peer network in which nodes may maintain respective copies of an append-only ledger.

The blockchain network may be a permissioned blockchain network in which only authorized nodes are permitted to add blocks to the blockchain. For example, only verified nodes may be granted permission to write to the blockchain. In other examples, the blockchain network may be a permissionless blockchain network.

In some embodiments, the client device 140 may, as illustrated, be a personal computer such as a smart phone. However, the client device 140 may be a computing device of another type such as a laptop computer, a desktop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. In certain embodiments, the client device 140 may be associated with one or more users. The one or more users may be, or may be associated with, the first entity, and may have resources associated with the first database management system 110. In some implementations, a user may operate the client device 140 to cause the client device 140 to perform one or more operations consistent with the disclosed embodiments. In some embodiments, the client device 140 may include a smart card, chip card, integrated circuit card (ICC), and/or other card having an embedded integrated circuit.

The client device 140 may be used, for example, to configure transfers of data resources. More particularly, the client device 140 may be used to configure data resource transfers from an account associated with a first entity operating the client device 140. A data resource transfer may involve a transfer of data between a data record maintained by the first database management system 110 (FIG. 1) associated with such an account and another data record in the second database management system 150 (FIG. 1). The other data record may be associated with a second entity such as, for example, a merchant. The data resources involved in the transfer may, for example, be units of value and the data records involved in the data transfer may be adjusted in related or corresponding manners. For example, during a data or value transfer, a data record associated with the second entity may be adjusted to reflect an increase in value due to the transfer whereas the data record associated with the first entity may be adjusted to reflect a decrease in value which is at least as large as the increase in value applied to the data record associated with the second entity.

The client device 140 may communicate with the transfer rail server 130 to initiate a data resource transfer. The client device 140 may communicate with the transfer rail server 130 via a transfer gateway, which may be a payment gateway. The transfer rail server 130 may relay transaction data to an appropriate issuer system which may be, for example, the first database management system. The transfer rail server 130 may be a real time transfer rail server, and may be referred to as a payment rail. Such communication may be via a network, such as the network 160.

The POS terminal 120 may also communicate with the transfer rail server 130 to initiate a data resource transfer. The POS terminal 120 is associated with an acquirer and the communication between the POS terminal 120 and the transfer rail server 130 may be by way of a back-end acquirer system. The POS terminal 120 may be located at a location that is associated with the second entity, which may be a merchant. By way of example, the merchant may be a store, restaurant, gym, etc. The acquirer is a merchant bank that accepts deposits associated with transactions made at the point-of-sale terminal and facilitates settlement and deposit of those deposits into an account associated with the merchant.

While a single transfer rail 130 is illustrated in FIG. 1, in practice the POS terminal 120 and/or the client device 140 may communicate with multiple transfer rails. By way of example, the transfer rail 130 may include any one or a combination of Amex™, Visa™ and/or Mastercard™. Other transfer rails may also be used. The POS terminal 120 and/or a back-end acquirer system in communication with the POS terminal 120 may, after obtaining data from a physical token, such as a value transfer card or a mobile device having a representation of a payment card which has engaged a physical token reader provided at the POS terminal 120, determine which of the transfer rails is to be used. For example, the POS terminal/acquirer system may determine that the physical token is associated with Visa™ and may, in response, select the Visa™ payment rail or it may, instead, determine that the physical token is associated with Mastercard™ and select the Mastercard™ payment rail.

After a transfer rail 130 is identified, the POS terminal/acquirer system and/or the client device sends the transfer rail 130 a message. The message may be sent through a network, such as the network 160. The message includes a value amount representing an amount of value that is to be transferred to complete a transaction and physical token data such as a primary account number (PAN) associated with a physical token. The transfer rail 130 identifies an associated issuer based on the physical token data and communicates with the identified issuer to process the transaction. More particularly, the transfer rail 130 routes the message received from the POS terminal 120 and/or the client device to an issuer system for the identified issuer. The issuer system then determines whether the transaction is approved or denied based on pre-defined rules. The rules may, for example, consider any one or more of: whether the cardholder has available funds, whether the merchant is of a type that is permitted, whether the transaction violates any spending limits, etc.

When the issuer system determines whether to approve or deny the transaction, it sends a message indicating the result of this determination to the POS terminal 120 via the transfer rail 130. The result may then be displayed or otherwise output at the POS terminal 120. The displayed result may indicate an approve response or a decline response.

In at least some embodiments, the transfer rail server 130 may facilitate transfers between data records. A data transfer request may include a request to transfer data from a first data record to a second data record. The first data record may be associated with an account associated with a first entity and the second data record may be associated with an account associated with a second entity. The first data record may be a data record maintained by the first database management system 110 and the second data record may be a data record maintained the second database management system 150. The transfer rail server 130 may operate as an intermediary between the first database management system 110 and the second database management system 150.

A data transfer request may include a pre-authorization request. The pre-authorization request may be a request to be reserve an identified amount of resources. The identified amount of resources may be described as a transaction amount. The pre-authorization request may be formatted as an ISO 8583 compliant message, and the ISO 8583 compliant message may include one or more parameters and/or data elements. The one or more parameters may include resource definition data defining what is requested to be transferred, and may include the transaction amount. By way of example, the resource definition data may define a resource that is stored in or otherwise associated with a data record. The resource may represent an amount of value, such as a quantity of a currency.

The ISO 8583 compliant message may also include one or more data elements. The one or more data elements may indicate one or more blockchain addresses. The one or more blockchain addresses may, for example, be associated with the second entity, for example, with a merchant. The indication of a first blockchain address within one or more data elements of the ISO 8583 message may indicate that the second entity is willing to accept an equivalent value of cryptocurrency in lieu of the data resources defined by the message. The pre-authorization message may further indicate which cryptocurrency may be accepted, for example, the message may indicate Bitcoin, Ethereum, Ripple, etc.

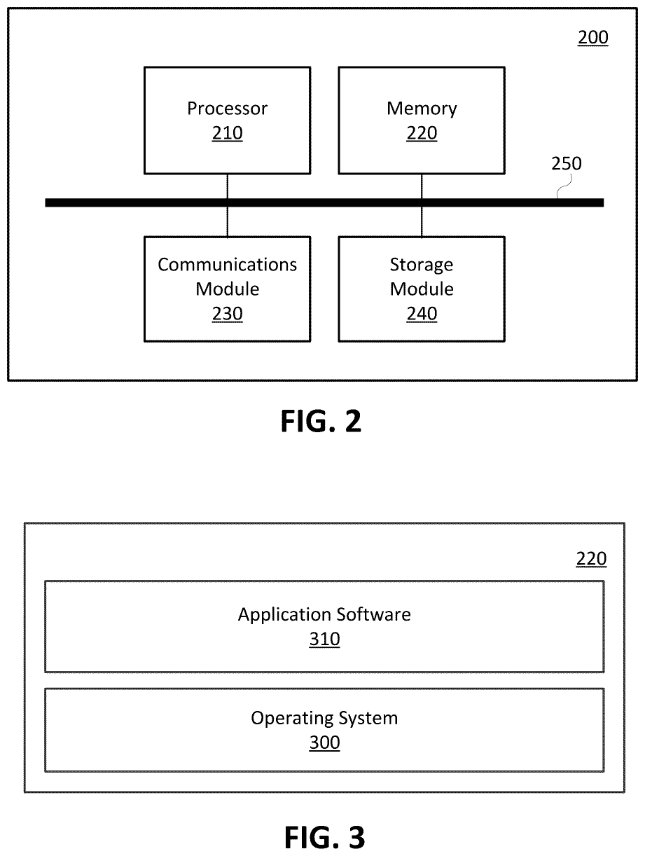

Referring now to FIG. 2, a high-level operation diagram of an example computing device 200 will now be described. The example computing device 200 may be exemplary of the first database management system 110, the client device 140, the second database management system 150, the transfer rail 130, and the POS terminal 120.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The computing device 200 will include other components apart from those illustrated in FIG. 2 and the specific component set may differ based on whether the computing device 200 is operating as the first database management system 110, the client device 140, the second database management system 150, the transfer rail 130, and/or the POS terminal 120. For example, the computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the computing devices 200 may include one or more output modules, which may be in communication with the processor 210 (e.g., over the bus 250). The output modules include one or more display modules which may be of various types including. for example, liquid crystal displays (LCD), light emitting diode displays (LED), cathode ray tube (CRT) displays, etc. By way of further example, the output modules may include a speaker.

Where the computing device 200 is operating as the POS terminal 120, the computing device 200 may include a physical token reader. The physical token reader is configured for reading a physical token such as a value transfer card or a mobile device having a representation of a value transfer card stored thereon. The physical token reader may be or include a card slot which facilitates communication with the physical token through physical contact and/or a contactless reader such as a near field communication (NFC) reader which may facilitate communication with the physical token through communication protocols that do not rely on physical contact with the physical token.

As noted above, the computing device 200 may include one or more input modules and/or one or more output modules. For example, where the computing device 200 is operating as the POS terminal 120 it may include one or more input modules such as a touchscreen display and/or a keypad that may be configured to receive user input. Where the computing device 200 is operating as the POS terminal 120, it may also include a display module which is used for displaying a user interface that facilitates payment processing.

The input and output modules and communications module are devices and may include, for example, hardware components, circuits and/or chips.

FIG. 3 depicts a simplified organization of software components stored in the memory 220 of the example computing device 200 (FIG. 2). As illustrated, these software components include an operating system 300 and an application software 310.

The operating system 300 is software. The operating system 300 allows the application software 310 to access the processor 210 (FIG. 2), the memory 220, and the communications module 230 of the example computing device 200 (FIG. 2). The operating system 300 may be, for example, Google™ Android™, Apple™ iOS™, UNIX™, Linux™, Microsoft™ Windows™, Apple OSX™ or the like.

The application software 310 adapts the example computing device 200, in combination with the operating system 300, to operate as a device performing a particular function. For example, the application software 310 may cooperate with the operating system 300 to adapt a suitable embodiment of the example computing device 200 to operate as the first database management system 110, the client device 140, the second database management system 150, the transfer rail 130, and/or the POS terminal 120.

While a single application software 310 is illustrated in FIG. 3, in operation the memory 220 may include more than one application software 310 and different application software 310 may perform different operations.

Where the example computing device is operating as the client device 140, the application software 310 may be or include an issuer application. The issuer application may configure the client device 140 to interact with the issuer system, which may be the first database management system 110. The issuer application may be, for example, a transfer management application such as a banking application. The banking application may, for example, be configured to display a quantum of value in one or more data records (e.g., display balances), configure or request that operations such as transfers of value (e.g., bill payments, email money transfers and other transfers) be performed, and perform other account management functions.

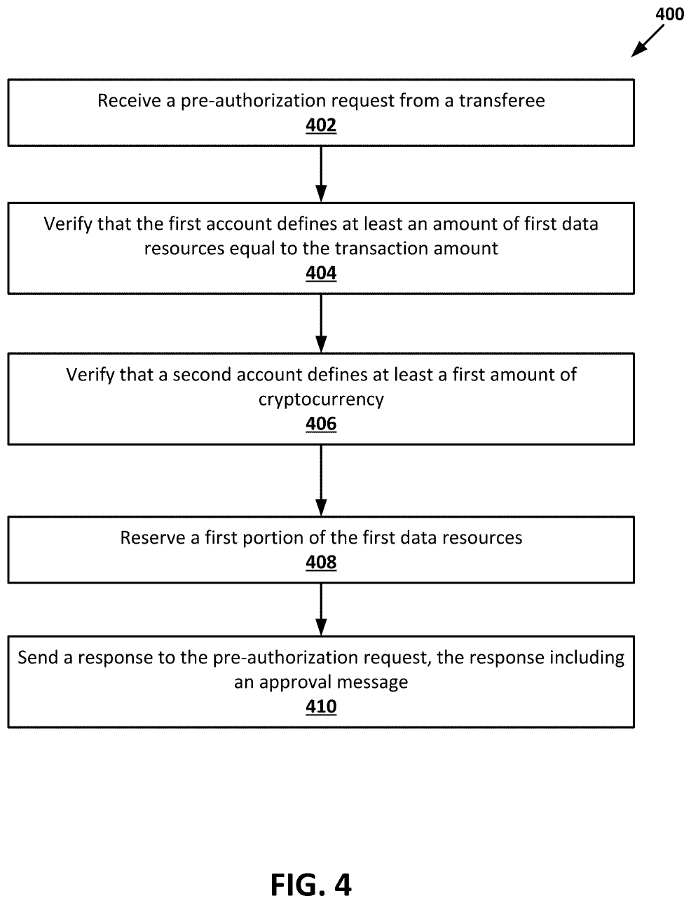

An operation of the first database management system 110 (FIG. 1) will now be described with reference to the flowchart of FIG. 4 which illustrates a method 400 for sending a response to a pre-authorization request, the response including an approval message. Operations 402 and onward are performed by one or more processors of a computing device, such as for example the processor 210 of a suitably configured instance of the example computing device 200, executing software such as, for example, a suitable instance of the application 310.

At the operation 402, the first database management system receives a pre-authorization request from a second entity. The pre-authorization request defines a first account, a transaction amount, and a first blockchain address to which cryptocurrency may be sent to release a reserved data resource. The pre-authorization request may be received via the POS terminal 120 (FIG. 1) or via an online transfer gateway. The pre-authorization request may be in the form of an ISO 8583 compliant message, and the first blockchain address may be indicated within one or more data elements of the ISO 8583 compliant message. The indication of the first blockchain address within one or more data elements of the ISO 8583 compliant message may indicate that the second entity is willing to accept an equivalent value of cryptocurrency in lieu of the amount of resources identified by the message. The pre-authorization message may further indicate which cryptocurrency may be accepted, for example, the message may indicate Bitcoin, Ethereum, Ripple, etc. In some implementations, the pre-authorization message may indicate that multiple cryptocurrencies are supported and a first blockchain address associated with each indicated cryptocurrency may be provided within the ISO 8583 data elements.

At the operation 404, the system verifies that the first account defines at least an amount of first data resources equal to the transaction amount. For example, as noted, the first database 170 (FIG. 1) may include data records for a plurality of accounts and at least some of the records may define a quantity of resources associated with an entity, such as the first entity, which may be a customer. The amount of resources that are available to or associated with an entity may be reflected by a resource definition defined in an associated record. The resource definition may be or include a balance defined in an associated record, for example, a bank balance and/or an amount of available credit. In some embodiments, the system may verify that the balance associated with the first account is greater than or equal to the transaction amount.

At the operation 406, the system verifies that a second account defines at least a first amount of cryptocurrency. The second account is associated with the first account, and the first amount of cryptocurrency has a value that is equal to the transaction amount.

The second account may be a cryptocurrency account that is associated with the first account. For example, the first account may reflect an amount of first data resources associated with the first entity and the second account may reflect an amount of cryptocurrency associated with the first entity. In some embodiments, verifying that the second account defines at least a first amount of cryptocurrency may include verifying that the first entity has sufficient unspent transaction output (UTXO) on a cryptocurrency rail based on a public blockchain.

At the operation 408, the system reserves a first portion of the first data resources. The first portion of the first data resources is equal to the transaction amount. In some embodiments, reserving a first portion of the first data resources includes placing a hold on a first portion of the first data resources.

At the operation 410, the system sends a response to the pre-authorization request, the response including an approval message. In some embodiments, the response to the pre-authorization request may include an identification of the second account and may include, for example, a second blockchain address. The second blockchain address may be associated with the second account.

In some embodiments, subsequent to sending a response to the pre-authorization request, the system may receive a pre-authorization release message from the second entity. In response to receiving the per-authorization release message from the second entity, the system may release the first portion of the first data resources.

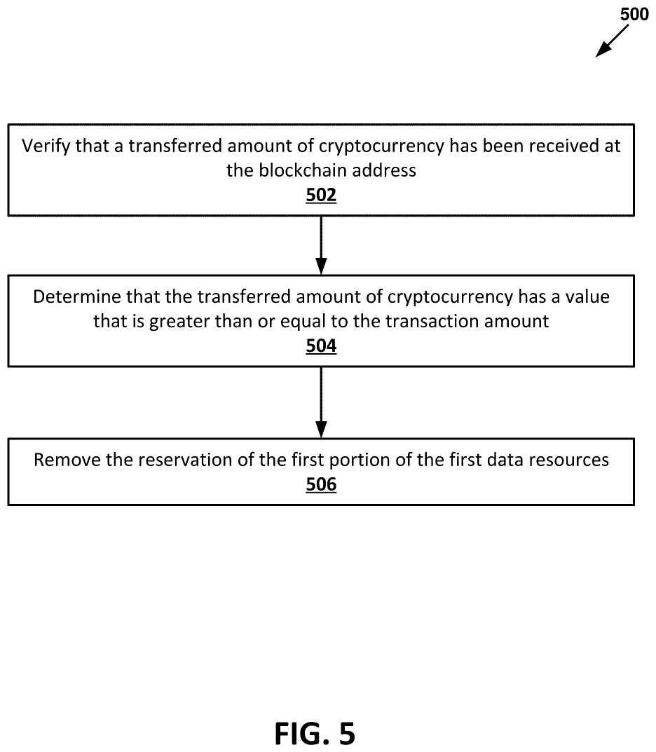

A further operation of the first database management system 110 (FIG. 1) will now be described with reference to the flowchart of FIG. 5 which illustrates a method 500 for removing a reservation of a first portion of first data resources. Operations 502 and onward are performed by one or more processors of a computing device, such as for example the processor 210 of a suitably configured instance of the example computing device 200, executing software such as, for example, a suitable instance of the application 310.

At the operation 502, the system verifies that a transferred amount of cryptocurrency has been received at the first blockchain address from the second account. As noted, in some implementations, the second account may be associated with a second blockchain address. In some such implementations, verifying that the transferred amount of cryptocurrency has been received at the first blockchain address from the second account may include verifying that the transferred amount of cryptocurrency was received at the first blockchain address from the second blockchain address. Additionally or alternatively, in some such implementations, verifying that the transferred amount of cryptocurrency has been received at the first blockchain address from the second account may include verifying one or more corresponding blockchain transactions based on the blockchain address.

At the operation 504, the system determines that the transferred amount of cryptocurrency has a value that is greater than or equal to the transaction amount. In some embodiments, the system may use an exchange rate to determine the value of the transferred amount of cryptocurrency relative to the transaction amount. For example, the transaction amount may be defined by a first currency unit and the transferred amount of cryptocurrency may be defined by a second currency unit, and an exchange rate may be determined with respect to the first currency unit and the second currency unit. The system may use the exchange rate to determine that the transferred amount of cryptocurrency has a value that is greater than or equal to the transaction amount.

At the operation 506, in response to determining that the transferred amount of cryptocurrency has a value that is greater than or equal to the transaction amount, the system removes the reservation of the first portion of the first data resources. In this way, a reserved data resource may be released.

In some embodiments, following removing the reservation of the first portion of the first data resources, the system may send a notification to the second entity indicating that the transferred amount of cryptocurrency having a value equal to the transaction amount has been received at the blockchain address.

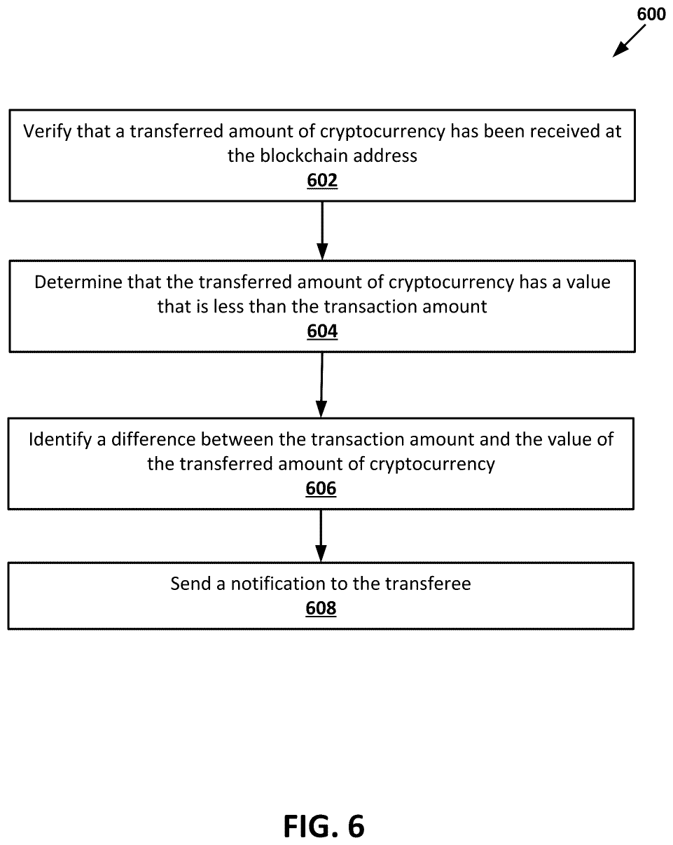

A still further operation of the first database management system 110 (FIG. 1) will now be described with reference to the flowchart of FIG. 6 which illustrates a method 600 for sending a notification identifying a difference. Operations 602 and onward are performed by one or more processors of a computing device, such as for example the processor 210 of a suitably configured instance of the example computing device 200, executing software such as, for example, a suitable instance of the application 310.

At the operation 602, the system verifies that a transferred amount of cryptocurrency has been received at the first blockchain address from the second account. As noted, in some implementations the second account may be associated with a second blockchain address. In some such implementations, verifying that the transferred amount of cryptocurrency has been received at the first blockchain address from the second account may include verified that the transferred amount of cryptocurrency was received from the second blockchain address.

At the operation 604, the system determines that the transferred amount of cryptocurrency has a value that is less than the transaction amount. In some embodiments, the system may use the exchange rate to determine the value of the transferred amount of cryptocurrency relative to the transaction amount. For example, the transaction amount may be defined by a first currency unit and the transferred amount of cryptocurrency may be defined by a second currency unit, and an exchange rate may be determined with respect to the first currency unit and the second currency unit. The system may use the exchange rate to determine that the transferred amount of cryptocurrency has a value that is less than or equal to the transaction amount.

At the operation 606, the system identifies a difference between the transaction amount and the value of the transferred amount of cryptocurrency.

At the operation 608, the system sends a notification to the second entity including the difference between the transaction amount and the value of the transferred amount of cryptocurrency.

In some embodiments, subsequent to identifying a difference between the transaction amount and the value of the transferred amount of cryptocurrency, the system may adjust the reservation of the first portion of data resources to be equal to the difference between the transaction amount and the value of the transferred amount of cryptocurrency. In this way, the sum of the value of the transferred amount of cryptocurrency and the adjusted reservation of the first portion of data resources may be equal to the value of the transaction amount.

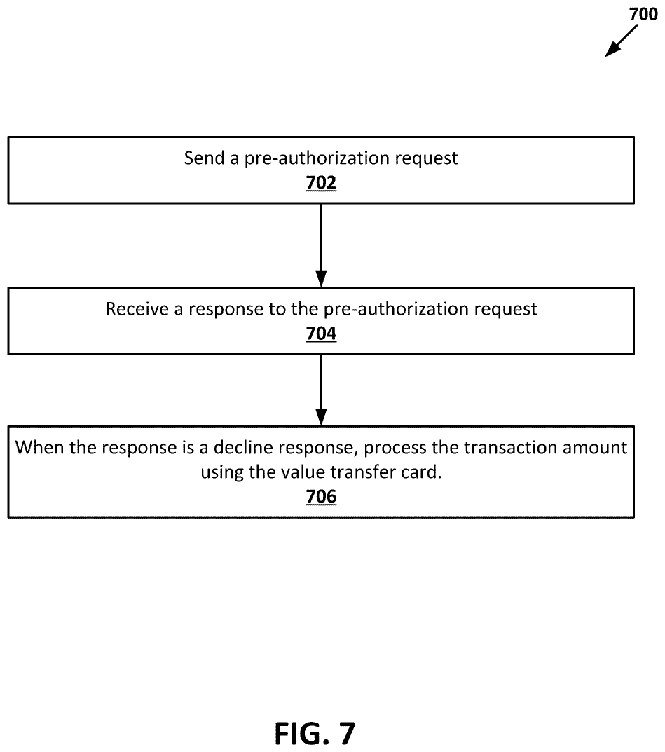

An operation of the second database management system 150 (FIG. 1) will now be described with reference to the flowchart of FIG. 7 which illustrates a method 700 for processing a transaction in response to receiving a decline response. Operations 702 and onward are performed by one or more processors of a computing device, such as for example the processor 210 of a suitably configured instance of the example computing device 200, executing software such as, for example, a suitable instance of the application 310.

At the operation 702, the system sends, to a system associated with a value transfer card, a pre-authorization request. The pre-authorization request defines a first account, a transaction amount, and a blockchain address to which cryptocurrency may be sent to release a reserved data resource. The system associated with the value transfer card may be, for example, the first database management system 110 (FIG. 1). The pre-authorization request may be sent from the POS terminal 120 (FIG. 1) or via an online transfer gateway. The pre-authorization request may be in the form of an ISO 8583 compliant message, and a first blockchain address may be indicated within one or more data elements of the ISO 8583 complaint message. The indication of a first blockchain address within one or more data elements of the ISO 8583 compliant message may indicate that the second entity is willing to accept an equivalent value of cryptocurrency in lieu of the amount of resources identified by the message. The pre-authorization message may further indicate which cryptocurrency may be accepted, for example, the message may indicate Bitcoin, Ethereum, XRP, etc. In some implementations, the pre-authorization message may indicate that multiple cryptocurrencies are supported and a first blockchain address associated with each indicated cryptocurrency may be provided within the ISO 8583 data elements.

At the operation 704, the system receives, from the system associated with the value transfer card, a decline response to the pre-authorization request.

At the operation 706, the system processes the transaction amount using the value transfer card.

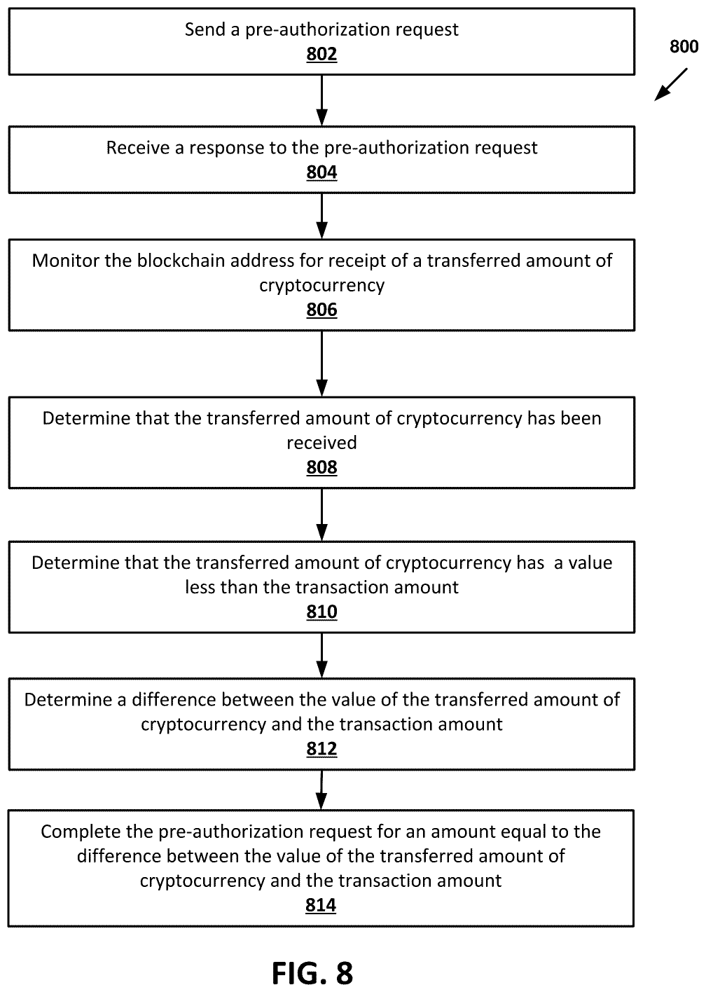

A further operation of the second database management system 150 (FIG. 1) will now be described with reference to the flowchart of FIG. 8 which illustrates a method 800 for completing a pre-authorization request for an amount equal to a difference, when a response equals an approve response. In some embodiments, the response may include an identification of the second account, such as a second blockchain address associated with the second account. Operations 802 and onward are performed by one or more processors of a computing device, such as for example the processor 210 of a suitably configured instance of the example computing device 200, executing software such as, for example, a suitable instance of the application 310.

At the operation 802, the system sends, to a system associated with a value transfer card, a pre-authorization request. The pre-authorization request defines a first account, a transaction amount, and a blockchain address to which cryptocurrency may be sent to release a reserved data resource. The system associated with the value transfer card may be, for example, the first database management system 110 (FIG. 1). The pre-authorization request may be sent from the POS terminal 120 (FIG. 1) or via an online transfer gateway. The pre-authorization request may be in the form of an ISO 8583 compliant message, and a first blockchain address may be indicated within one or more data elements of the ISO 8583 complaint message. The indication of a first blockchain address within one or more data elements of the ISO 8583 compliant message may indicate that the second entity is willing to accept an equivalent value of cryptocurrency in lieu of the amount of resources identified by the message. The pre-authorization message may further indicate which cryptocurrency may be accepted, for example, the message may indicate Bitcoin, Ethereum, XRP, etc. In some implementations, the pre-authorization message may indicate that multiple cryptocurrencies are supported and a first blockchain address associated with cach indicated cryptocurrency may be provided within the ISO 8583 data elements.

At the operation 804, the system receives, from the system associated with the value transfer card, an approve response to the pre-authorization request. In some embodiments, the response may include an identification of a second account.

At the operation 806, the system monitors the first blockchain address for receipt of a transferred amount of cryptocurrency. The transferred amount of cryptocurrency may be received from the second account and the second account may be associated with the first account.

At the operation 808, the system determines that the transferred amount of cryptocurrency has been received via the blockchain address.

At the operation 810, the system determines that the transferred amount of cryptocurrency has a value that is less than the transaction amount. In some embodiments, the system may use the exchange rate to determine the value of the transferred amount of cryptocurrency relative to the transaction amount. For example, the transaction amount may be defined by a first currency unit and the transferred amount of cryptocurrency may be defined by a second currency unit, and an exchange rate may be determined with respect to the first currency unit and the second currency unit. The system may use the exchange rate to determine that the transferred amount of cryptocurrency has a value that is less than the transaction amount.

At the operation 812, the system determines a difference between the value of the transferred amount of cryptocurrency and the transaction amount.

At the operation 814, the system completes the pre-authorization request for an amount equal to the difference between the value of the transferred amount of cryptocurrency and the transaction amount. In this way, the sum of the value of the transferred amount of cryptocurrency and the amount of the completed pre-authorization request may be equal to the value of the transaction amount.

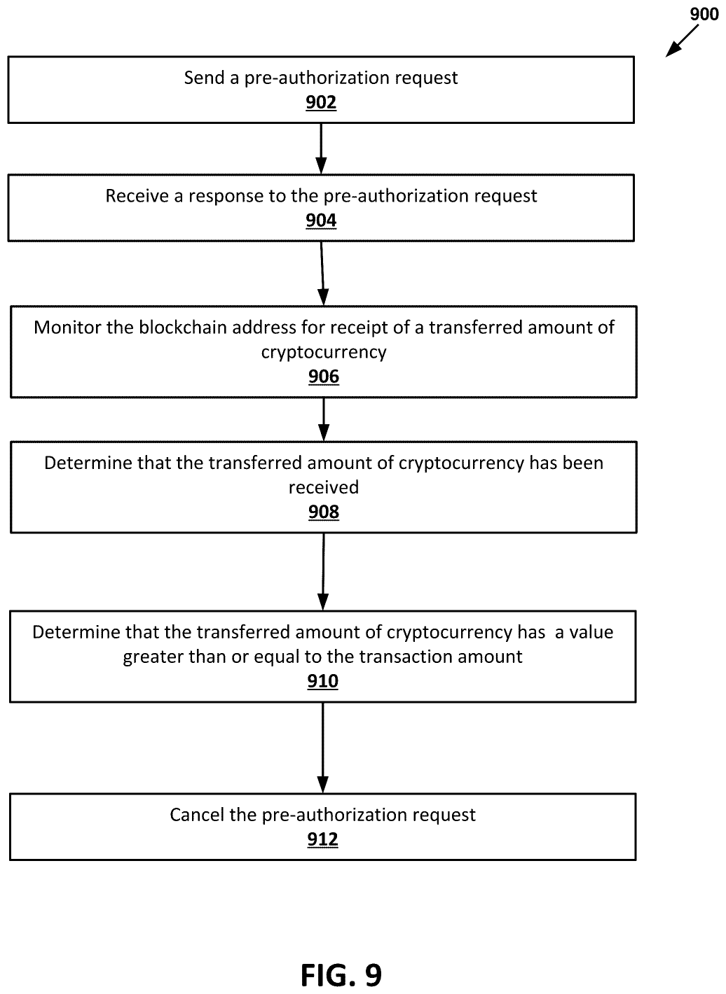

A still further operation of the second database management system will now be described with reference to the flowchart of FIG. 9 which illustrates a method 900 for canceling a pre-authorization request, when a response is an approve response. In some embodiments, the response may include an identification of the second account, such as a second blockchain address associated with the second account. Operations 902 and onward are performed by one or more processors of a computing device, such as for example the processor 210 of a suitably configured instance of the example computing device 200, executing software such as, for example, a suitable instance of the application 310.

At the operation 902, the system sends, to a system associated with a value transfer card, a pre-authorization request. The pre-authorization request defines a first account, a transaction amount, and a blockchain address to which cryptocurrency may be sent to release a reserved data resource. The system associated with the value transfer card may be, for example, the first database management system 110 (FIG. 1). The pre-authorization request may be sent from the POS terminal 120 (FIG. 1) or via an online transfer gateway. The pre-authorization request may be in the form of an ISO 8583 compliant message, and a first blockchain address may be indicated within one or more data elements of the ISO 8583 complaint message. The indication of a first blockchain address within one or more data elements of the ISO 8583 compliant message may indicate that the second entity is willing to accept an equivalent value of cryptocurrency in lieu of the amount of resources identified by the message. The pre-authorization message may further indicate which cryptocurrency may be accepted, for example, the message may indicate Bitcoin, Ethereum, XRP, etc. In some implementations, the pre-authorization message may indicate that multiple cryptocurrencies are supported and a first blockchain address associated with each indicated cryptocurrency may be provided within the ISO 85833 data elements.

At the operation 904, the system receives, from the system associated with the value transfer card, an approve response to the pre-authorization request.

At the operation 906, the system monitors the first blockchain address for receipt of a transferred amount of cryptocurrency. The transferred amount of cryptocurrency may be received from the second account and the second account may be associated with the first account.

At the operation 908, the system determines that the transferred amount of cryptocurrency has been received via the blockchain address.

At the operation 910, the system determines that the transferred amount of cryptocurrency has a value that is greater than or equal to the transaction amount. In some embodiments, the system may use the exchange rate to determine the value of the transferred amount of cryptocurrency relative to the transaction amount. For example, the transaction amount may be defined by a first currency unit and the transferred amount of cryptocurrency may be defined by a second currency unit, and an exchange rate may be determined with respect to the first currency unit and the second currency unit. The system may use the exchange rate to determine that the transferred amount of cryptocurrency has a value that is greater than or equal to the transaction amount.

At the operation 912, cancels the pre-authorization request.

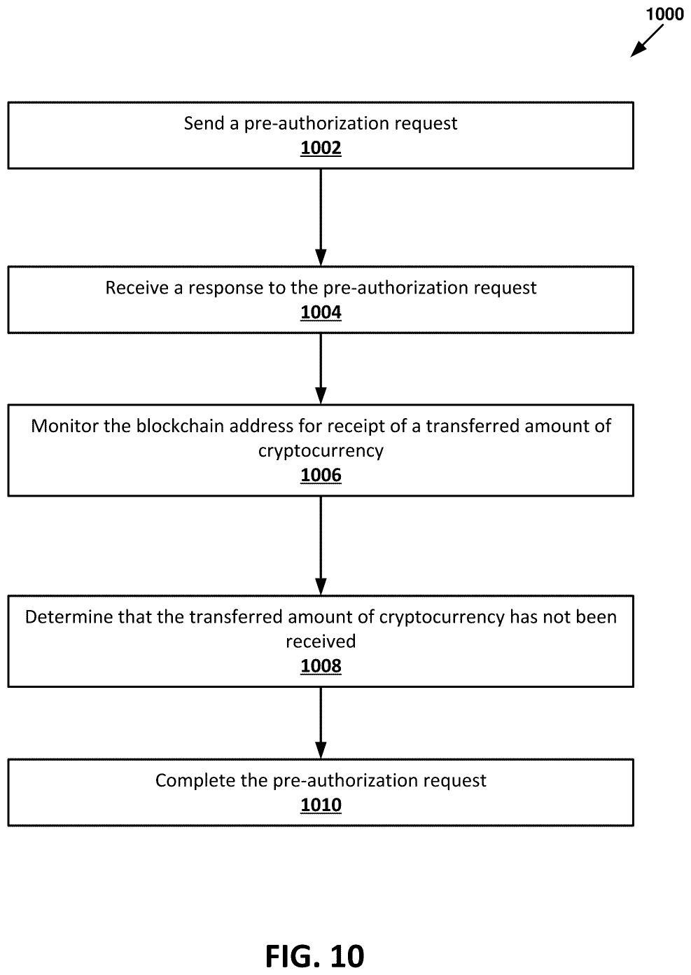

A still further operation of the second database management system 150 (FIG. 1) will now be described with reference to the flowchart of FIG. 10 which illustrates a method 1000 for completing a pre-authorization request, when a response is an approve response. In some embodiments, the response may include an identification of the second account, such as a second blockchain address associated with the second account. Operations 1002 and onward are performed by one or more processors of a computing device, such as for example the processor 210 of a suitably configured instance of the example computing device 200, executing software such as, for example, a suitable instance of the application 310.

At the operation 1002, the system sends, to a system associated with a value transfer card, a pre-authorization request. The pre-authorization request defines a first account, a transaction amount, and a blockchain address to which cryptocurrency may be sent to release a reserved data resource. The system associated with the value transfer card may be, for example, the first database management system 110 (FIG. 1). The pre-authorization request may be sent from the POS terminal 120 (FIG. 1) or via an online transfer gateway. The pre-authorization request may be in the form of an ISO 8583 compliant message, and a first blockchain address may be indicated within one or more data elements of the ISO 8583 complaint message. The indication of a first blockchain address within one or more data elements of the ISO 8583 compliant message may indicate that the second entity is willing to accept an equivalent value of cryptocurrency in lieu of the amount of resources identified by the message. The pre-authorization message may further indicate which cryptocurrency may be accepted, for example, the message may indicate Bitcoin, Ethereum, XRP, etc. In some implementations, the pre-authorization message may indicate that multiple cryptocurrencies are supported and a first blockchain address associated with cach indicated cryptocurrency may be provided within the ISO 85833 data elements.

At the operation 1004, the system receives, from the system associated with the value transfer card, an approve response to the pre-authorization request.

At the operation 1006, the system monitors the first blockchain address for receipt of a transferred amount of cryptocurrency. The transferred amount of cryptocurrency may be received from the second account and the second account may be associated with the first account.

At the operation 1008, the system determines that the transferred amount of cryptocurrency has not been received via the blockchain address.

At the operation 1010, the system completes the pre-authorization request.

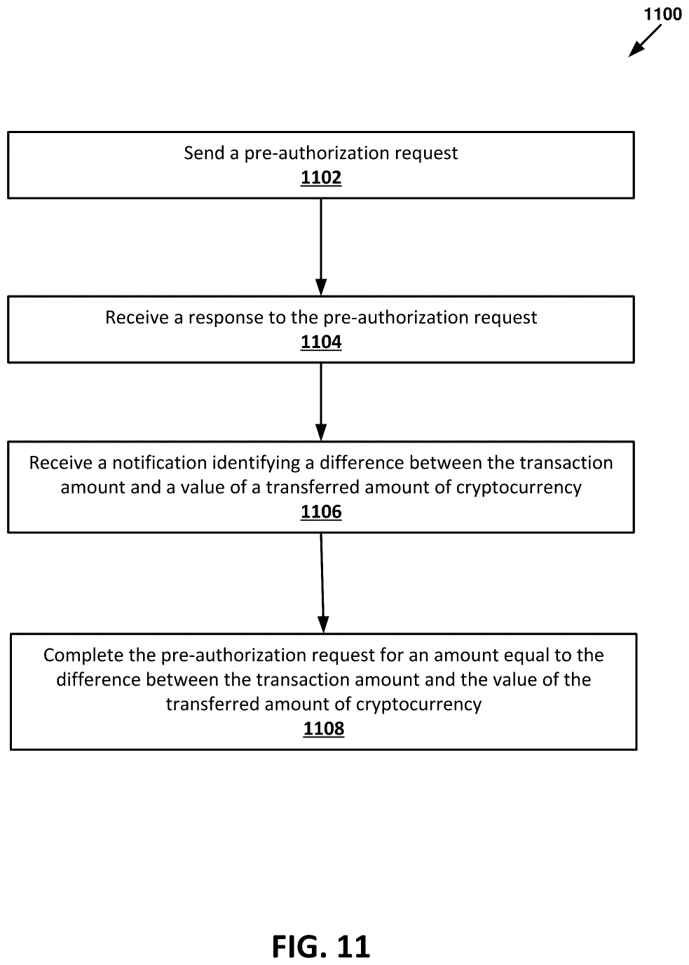

A still further operation of the second database management system 150 (FIG. 1) will now be described with reference to the flowchart of FIG. 11 which illustrates a method 1100 for completing a pre-authorization request for an amount equal to a difference when a response is an approve response. In some embodiments, the response may include an identification of the second account, such as a second blockchain address associated with the second account. Operations 1102 and onward are performed by one or more processors of a computing device, such as for example the processor 210 of a suitably configured instance of the example computing device 200, executing software such as, for example, a suitable instance of the application 310.

At the operation 1102, the system sends, to a system associated with a value transfer card, a pre-authorization request. The pre-authorization request defines a first account, a transaction amount, and a blockchain address to which cryptocurrency may be sent to release a reserved data resource. The system associated with the value transfer card may be, for example, the first database management system 110 (FIG. 1). The pre-authorization request may be sent from the POS terminal 120 (FIG. 1) or via an online transfer gateway. The pre-authorization request may be in the form of an ISO 8583 compliant message, and a first blockchain address may be indicated within one or more data elements of the ISO 8583 complaint message. The indication of a first blockchain address within one or more data elements of the ISO 8583 compliant message may indicate that the second entity is willing to accept an equivalent value of cryptocurrency in lieu of the amount of resources identified by the message. The pre-authorization message may further indicate which cryptocurrency may be accepted, for example, the message may indicate Bitcoin, Ethereum, XRP, etc. In some implementations, the pre-authorization message may indicate that multiple cryptocurrencies are supported and a first blockchain address associated with cach indicated cryptocurrency may be provided within the ISO 85833 data elements.

At the operation 1104, the system receives, from the system associated with the value transfer card, an approve response to the pre-authorization request.

At the operation 1106, the system receives a notification identifying a difference between the transaction amount and a value of a transferred amount of cryptocurrency.

At the operation 1108, the system completes the pre-authorization request for an amount equal to the difference between the transaction amount and the value of the transferred amount of cryptocurrency. In this way, the sum of the value of the transferred amount of cryptocurrency and the amount of the completed pre-authorization request may be equal to the value of the transaction amount.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
a processor; and
a memory coupled to the processor and storing instructions that, when executed by the processor, cause the computer system to:
receive a pre-authorization request from a second entity, the pre-authorization request defining a first account, a transaction amount, and a blockchain address to which cryptocurrency may be sent to release a reserved data resource;
verify that the first account defines at least an amount of first data resources equal to the transaction amount;
verify that a second account defines at least a first amount of cryptocurrency having a value that is equal to the transaction amount, the second account being associated with the first account;
reserve a first portion of the first data resources, the first portion of the first data resources being equal to the transaction amount; and
send a response to the pre-authorization request, the response including an approval message.

2. The system of claim 1, wherein the processor is further configured to:
verify that a transferred amount of cryptocurrency has been received at the blockchain address from the second account;
determine that the transferred amount of cryptocurrency has a value that is greater than or equal to the transaction amount; and
in response to determining that the transferred amount of cryptocurrency has a value that is greater than or equal to the transaction amount, remove the reservation of the first portion of the first data resources.

3. The system of claim 2, wherein the processor is further configured to:
send a notification to the second entity indicating that the transferred amount of cryptocurrency having a value greater than or equal to the transaction amount has been received at the blockchain address.

4. The system of claim 2, wherein verifying that a transferred amount of cryptocurrency has been received at the blockchain address from the second account includes verifying one or more corresponding blockchain transactions based on the blockchain address.

5. The system of claim 1, wherein the processor is further configured to:
verify that a transferred amount of cryptocurrency has been received at the blockchain address from the second account;
determine that the transferred amount of cryptocurrency has a value that is less than the transaction amount;
identify a difference between the transaction amount and the value of the transferred amount of cryptocurrency; and
send a notification to the second entity, the notification including the difference between the transaction amount and the value of the transferred amount of cryptocurrency.

6. The system of claim 5, wherein the processor is further configured to:
adjust the reservation of the first portion of data resources to be equal to the difference between the transaction amount and the value of the transferred amount of cryptocurrency.

7. The system of claim 1, wherein the processor is further configured to:
receive a pre-authorization release message from the second entity; and
release the reservation of the first portion of the first data resources.

8. The system of claim 1, wherein the response to the pre-authorization request includes an identification of the second account.

9. The system of claim 1, wherein verifying that a second account defines at least a first amount of cryptocurrency having a value that is equal to the transaction amount includes verifying that the second account has sufficient unspent transaction output (UTXO) on a cryptocurrency rail.

10. The system of claim 1, wherein the pre-authorization request is an International Organization for Standardization (ISO) 8583 compliant message, and wherein the blockchain address is indicated by one or more data elements of the ISO 8583 compliant message.

11. The system of claim 1, wherein the pre-authorization request is received via a point-of-sale (POS) terminal.

12. The system of claim 1, wherein the pre-authorization request is received via an online transfer gateway.

13. A computer system comprising:
a processor; and
a memory coupled to the processor and storing instructions that, when executed by the processor, cause the computer system to:
send, to a system associated with a value transfer card, a pre-authorization request, the pre-authorization request defining a first account, a transaction amount, and a blockchain address to which cryptocurrency may be sent to release a reserved data resource;
receive, from the system associated with the value transfer card, a response to the pre-authorization request; and
when the response is a decline response, process the transaction amount using the value transfer card.

14. The system of claim 13, wherein the processor is further configured to:
when the response is an approve response:
monitor the blockchain address for receipt of a transferred amount of cryptocurrency from a second account associated with the first account;
determine that the transferred amount of cryptocurrency has been received via the blockchain address;
determine that the transferred amount of cryptocurrency has a value less than the transaction amount;
determine a difference between the value of the transferred amount of cryptocurrency and the transaction amount; and
complete the pre-authorization request for an amount equal to the difference between the value of the transferred amount of cryptocurrency and the transaction amount.

15. The system of claim 14, wherein the response includes an identification of the second account.

16. The system of claim 13, wherein the processor is further configured to:
when the response is an approve response:
monitor the blockchain address for receipt of a transferred amount of cryptocurrency from a second account associated with the first account;
determine that the transferred amount of cryptocurrency has been received via the blockchain address;
determine that the transferred amount of cryptocurrency has a value greater than or equal to the transaction amount; and
cancel the pre-authorization request.

17. The system of claim 13, wherein the processor is further configured to:
when the response is an approve response:
receive a notification identifying a difference between the transaction amount and a value of a transferred amount of cryptocurrency; and
complete the pre-authorization request for an amount equal to the difference between the transaction amount and the value of the transferred amount of cryptocurrency.

18. The system of claim 13, wherein the processor is further configured to:
when the response is an approve response:
monitor the blockchain address for receipt of a transferred amount of cryptocurrency from a second account associated with the first account;
determine that the transferred amount of cryptocurrency has not been received via the blockchain address; and
complete the pre-authorization request.

19. The system of claim 13, wherein the pre-authorization request is an International Organization for Standardization (ISO) 8583 compliant message, and wherein the blockchain address is indicated by one or more data elements of the ISO 8583 compliant message.

20. The system of claim 13, wherein the pre-authorization request is sent via a point-of-sale (POS) terminal.
